(19) United States
(12) Patent Application Publication
(10) Pub. No.: US 2004/0203850 A1
(43) Pub. Date: Oct. 14, 2004

(54) Method of mobile vehicle location determination

(75) Inventor: Christopher L. Oesterling, Troy, MI (US)

Correspondence Address: General Motors Corporation, Mail Code 482-C23-B21, 300 Renaissance Center, P.O. Box 300, Detroit, MI, 48265-3000, US

(73) Assignee: General Motors Corporation

(21) Appl. No.: 10/115,782

(22) Filed: Apr. 4, 2002

(51) Int. Cl. H04Q 7/20

(52) U.S. Cl. 455/456.1; 455/457

(57) ABSTRACT

The invention provides a method of determining the location of a mobile vehicle. A plurality of GPS signals in the mobile vehicle is received. Broadcast signals are monitored from a satellite radio system for at least one GPS correction signal. The GPS correction signal is extracted. A corrected mobile vehicle location is determined based on the GPS signals and the GPS correction signal.

### FIELD OF THE INVENTION

This invention relates generally to vehicle position determination. More specifically, the invention relates to a method for determining the position of a mobile vehicle that uses global positioning system signals and satellite radio signals with GPS correction data.

### BACKGROUND OF THE INVENTION

Global positioning and other location services are among the wireless communication services for automobiles and hand-held mobile phones that have been increasing greatly in variety and number in recent years.

Currently, many in-vehicle telematics devices have integrated global positioning system (GPS) units that aid in providing call center services such as navigation assistance, roadside assistance, information services assistance, and emergency assistance. A number of these services require or at least benefit from the wireless communication device being able to relay information on the current location of a vehicle from the GPS unit to the call center.

Global positioning systems use the U.S. Department of Defense's worldwide, satellite-based radio navigation system to determine a location of a GPS unit based on the positions of GPS satellites (also called NAVSTAR, the official U.S. Department of Defense name for GPS). GPS units typically use three or four satellites in a constellation to determine a longitudinal and latitudinal position of the GPS unit. Most GPS units are accurate within approximately 15 meters on average. Information from the GPS unit may not be as accurate as needed, for example, when a mobile vehicle that is off a road needs to be located, or when a vehicle is currently in a wrong traffic lane and needs to promptly make a left turn or right exit, or when a vehicle is determined to be on the opposite side of the road when providing navigational instructions.

Positional accuracy may be increased to less than three meters by applying GPS correction technology such as the Federal Aviation Administration FAA-developed Wide Area Augmentation System (WAAS), an enhanced GPS navigation system that employs approximately 25 precisely surveyed ground-reference stations. With WMS, signals from GPS satellites are received by wide area ground-reference stations, which may determine the integrity of the GPS satellite data and correct for atmospheric anomalies in the ionosphere such as transmission signal delays that may effect the time of reception at a GPS unit. The ground-reference stations relay data to a wide-area master station where correction information is computed using a correction algorithm, a correction message is prepared, and the message is uplinked to a geostationary satellite via a ground uplink system. The message is then broadcast on the same frequency as GPS to be received by enabled GPS units on aircraft, watercraft or mobile vehicles that are within the broadcast coverage area of the WAAS system. Most GPS equipment used today are unable to exploit the WAAS correction data.

Another GPS correction technology, differential global positioning system (DGPS), employs a supplemental differential GPS receiver and antenna with a GPS unit to receive correction data that may be used to correct GPS signals to within an average of three to five meters. The U.S. Coast Guard operates the most common DGPS correctional service with its network of towers that receive GPS signals and transmit a corrected signal by terrestrial radio transmitters typically located near bodies of water.

The above-mentioned correctional technologies improve the positional accuracy to approximately three meters on average. Differential GPS and WAAS system technologies require additional specialized radio equipment and unfortunately, many of the current GPS units in mobile vehicles are unable to exploit the more accurate location technology.

An improved method for locating a mobile vehicle would increase the reliability and quality of services that require accurate assessment of the vehicle position, such as emergency services, navigational services or directory assistance. The mobile vehicle user and telematics call center would benefit from being able to exploit additional and more accurate location information at the mobile vehicle without needing to replace current equipment or to install additional equipment. It is an object of this invention, therefore, to provide a more accurate method for determining the location of a mobile vehicle with currently installed GPS equipment, and to overcome the deficiencies and limitations described above.

### SUMMARY OF THE INVENTION

One aspect of the invention provides a method of locating a mobile vehicle. A plurality of GPS signals in the mobile vehicle may be received. Broadcast signals may be monitored from a satellite radio system for at least one GPS correction signal. The GPS correction signal may be extracted. A corrected mobile vehicle location may be determined based on the GPS signals and the GPS correction signal.

The GPS correction signal may be broadcast from a satellite radio geostationary satellite or a satellite radio terrestrial transmitter. Determining the corrected mobile vehicle location may include correcting the GPS signals based on the GPS correction signal and triangulating a vehicle position based on the corrected GPS signals.

The GPS signals may be received from at least three GPS satellites. The GPS correction data may be uplinked from a satellite radio uplink facility to a satellite radio geostationary satellite. GPS correction data may be sent from a satellite radio uplink facility to a terrestrial radio transmitter.

Another aspect of the invention provides a computer usable medium including a program for determining a location of a mobile vehicle. The computer program may include code to receive a plurality of GPS signals in the mobile vehicle. The program may include code to monitor broadcast signals from a satellite radio system for at least one GPS correction signal. The program may include code to extract the GPS correction signal. The program may include code to determine a corrected mobile vehicle location based on the GPS signals and the GPS correction signal.

The program may include code to uplink GPS correction data from a satellite radio uplink facility to a satellite radio geostationary satellite. The program may include code to send GPS correction data from a satellite radio uplink facility to a terrestrial radio transmitter.

Another aspect of invention provides a system for determining a location of a mobile vehicle including a means for receiving a plurality of GPS signals in the mobile vehicle; means for monitoring broadcast signals from a satellite radio system for at least one GPS correction signal; means for extracting the GPS correction signal; and means for determining a corrected mobile vehicle location based on the GPS signals and the GPS correction signal.

The system may include means for uplinking GPS correction data from a satellite radio uplink facility to a satellite radio geostationary satellite. The system may further include means for sending GPS correction data from a satellite radio uplink facility to a terrestrial radio transmitter.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an illustration of one embodiment of a system for locating a mobile vehicle, in accordance with the current invention; and

FIG. 2 is a flow diagram of one embodiment of a method for determining the location of a mobile vehicle, in accordance with the current invention.

### DETAILED DESCRIPTION OF THE PRESENTLY PREFERRED EMBODIMENTS

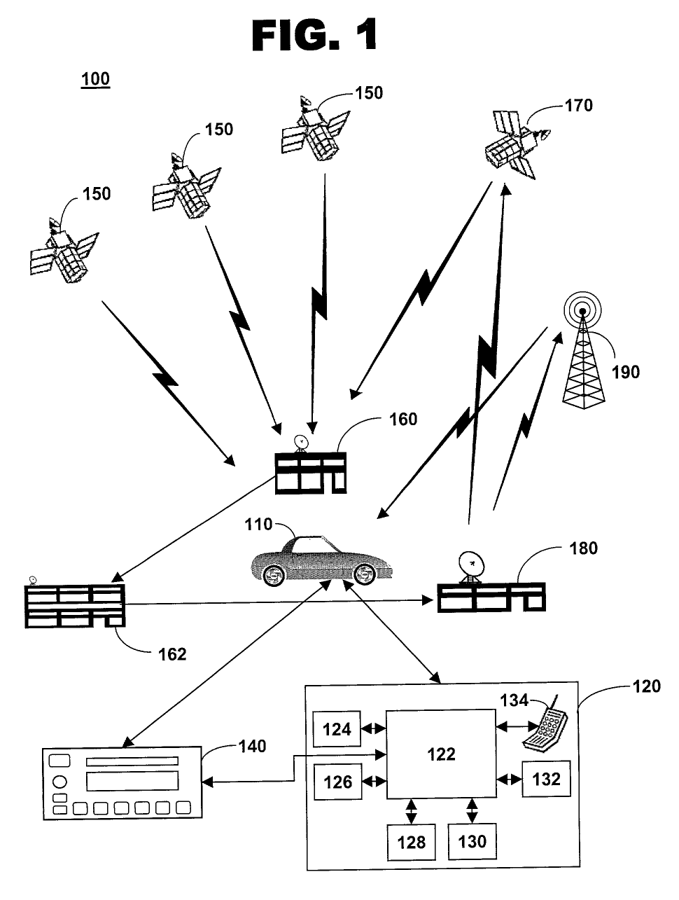

FIG. 1 shows one embodiment of a system for locating a mobile vehicle, in accordance with the present invention at 100. The invention leverages the infrastructure of a global positioning system and a satellite radio system. The position of a vehicle may be located by using an in-vehicle global positioning system unit that may receive GPS data from a GPS satellite, and a satellite radio receiver that may receive GPS correction data from a satellite radio geostationary satellite or a satellite radio terrestrial transmitter.

Vehicle location system 100 may include a mobile vehicle 110, a telematics unit 120, a satellite radio receiver 140, at least three GPS satellites 150, one or more local or ground-reference stations 160, a central or wide-area master station 162, one or more satellite radio geostationary satellites 170, one or more satellite radio uplink facilities 180, and one or more satellite radio terrestrial repeaters or satellite radio terrestrial transmitters 190.

Mobile vehicle 110 may be a mobile vehicle equipped with suitable hardware and software for transmitting and receiving voice and data communications. Mobile vehicle 110 may contain telematics unit 120 that may include a vehicle communications processor. Telematics unit 120 may include a digital signal processor (DSP) 122 connected to a wireless analog, digital or dual-mode modem 124, a global positioning system (GPS) unit 126, an in-vehicle memory 128, a microphone 130, one or more speakers 132, and a network access device (NAD) or in-vehicle mobile phone 134. In-vehicle mobile phone 134 may be an analog, digital, or dual-mode cellular phone.

GPS unit 126 may provide, for example, longitude and latitude coordinates of the vehicle. GPS unit 126 may receive signal information from three or more GPS satellites 150 of the approximately 25 U.S. Department of Defense GPS satellites and use triangulation to calculate its location. Essentially, GPS unit 126 may compare the time a signal was transmitted by GPS satellite 150 with the time it was received at the unit. The time difference indicates how far away the GPS satellite is, and with the distance measurements from the satellites, GPS unit 126 may determine its position using a position determination algorithm. Generally, the position may be accurate to within 15 meters.

DSP 122 may use instructions and data from a computer usable medium that may contain various computer programs for controlling programming and operational modes within mobile vehicle 110. For example, a voice-recognition application may be installed in DSP 122 that may translate human voice input through microphone 130 to digital signals. These and other signals from equipment in the vehicle may activate the programming mode and operation modes, as well as provide input and output data. DSP 122 may include one or more computer applications to process, manage and correct GPS location information from GPS satellites received by GPS unit 126 and GPS correction data received by satellite radio systems via satellite radio receiver 140. DSP 122 may include a program for determining a location of a mobile vehicle with code to receive a plurality of GPS signals in the mobile vehicle; to monitor broadcast signals from a satellite radio system for at least one GPS correction signal; to extract the GPS correction signal; and to determine a corrected mobile vehicle location based on the GPS signals and the GPS correction signal.

Satellite radio receiver 140 may be any suitable hardware for receiving satellite radio broadcast signals in mobile vehicle 110. Satellite radio receiver 140 may send and receive digital signals to and from telematics unit 120. Satellite radio receiver 140 may receive broadcasted signals containing news, weather, traffic information, music, and educational programming from one or more broadcast channels. Satellite radio receiver 140 may convert and output the received signals in audio and digital formats. Satellite radio receiver 140 may receive GPS correction data on a broadcast channel. The GPS correction data may be received on a dedicated broadcast channel, and may be made available to subscribers of telematics services to provide increased accuracy of GPS location information. Telematics unit 120 may monitor, filter and send signals that are received from satellite broadcasts, radio broadcasts or other wireless communication systems to output devices such as speaker 132 and visual display devices.

One or more precisely surveyed ground-reference stations 160 in the WAAS system may receive signals from a plurality of GPS satellites 150 to determine the integrity, accuracy and quality of the data. Ground-reference stations 160 may relay data to a wide-area master station 162 where correctional information may be computed with a predetermined algorithm. Ground-reference stations 160 may send this data to wide-area master station 162 via wireless or landline communication networks. A correction message with GPS correction data may be prepared and the message may be uplinked or transmitted by wide-area master station 162 to the network of satellites 150.

Wide-area master station 162 also may send a message with correction data to one or more satellite radio uplink facilities 180 that are part of a satellite radio system. Wide-area master station 162 may send data to satellite radio uplink facilitiy 180 via landline or wireless communication networks. Alternatively, satellite radio uplink facility 180 may receive the correction data from GPS satellite 150 via the facility's own WAAS-enabled GPS equipment.

Satellite radio geostationary satellite 170 may transmit radio signals to satellite radio receiver 140 in mobile vehicle 110. Satellite radio geostationary satellite 170 may broadcast, for example, over a spectrum in the “S” band (2.3 GHz) that has been allocated by the U.S. Federal Communications Commission (FCC) for nationwide broadcasting of satellite-based Digital Audio Radio Service (DARS). GPS correction signals may be broadcast, for example, on a portion of a dedicated 120 kilobyte-per-second channel of a satellite radio service.

Satellite radio geostationary satellite 170 may transmit radio signals containing data to satellite radio receiver 140 in mobile vehicle 110. Satellite radio receiver 140 may transmit digitized audio, digitized video, or data over each broadcast channel. The transmissions may be sent in the S band (approved for use in the U.S.) and L band (used in Europe and Canada). Telematics unit 120 may receive, monitor and store data and information from satellite radio receiver 140.

As part of a satellite radio service broadcast network, one or more satellite radio uplink facilities 180 may send and receive radio signals to and from a satellite radio geostationary satellite 170. Satellite radio uplink facility 180 may send GPS correctional data to satellite radio geostationary satellite 170. Satellite radio uplink facility 180 may receive GPS data and GPS correction data from wide-area master station 162. Satellite radio uplink facility 180 may receive GPS data and GPS correction data from the network of satellites 150.

Satellite radio uplink facility 180 also may send radio signals to one or more satellite radio terrestrial transmitters 190 for local broadcast with higher power. Broadcast services provided by a satellite radio broadcast system may be sent from satellite radio geostationary satellite 170 or satellite radio terrestrial transmitters 190 to satellite radio receiver 140. In addition to traffic information, road construction information, advertisements, news, and information on local events, GPS correction data may be sent. Telematics unit 120 may monitor broadcast signals on one or more broadcast channels received by satellite radio receiver 140 for broadcast signals with GPS correction data. When one or more GPS correction data signals are detected, telematics unit 120 may extract the correction data signal and determine a corrected mobile vehicle location based on the GPS signals. The determination of the corrected mobile vehicle location may include correcting the GPS signals based on the GPS correction signal and then triangulating a vehicle position based on the corrected GPS signals.

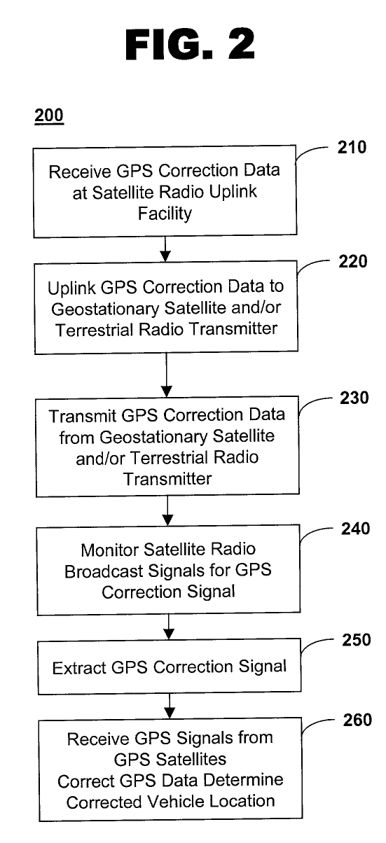

FIG. 2 shows one embodiment of a method for locating a mobile vehicle, in accordance with the present invention at 200. Vehicle location method 200 may comprise steps for a mobile vehicle to receive GPS data and GPS correction data from which a corrected vehicle location may be determined.

A satellite radio uplink facility may receive GPS correction data as seen at block 210. GPS correction data may be received from a ground-reference station or a wide-area master station where correctional information may be computed with a predetermined algorithm. One or more precisely surveyed ground-reference stations in the WAAS system may receive signals from a plurality of GPS satellites to determine if any errors exist and may relay data to a wide-area master station where correctional information may be computed. A computer application at the wide-area master station may determine GPS correction data. The wide-area master station may transmit the data over a wireless or landline network to the satellite radio uplink facility. Alternatively, the satellite radio uplink facility may receive GPS correction data directly from the network of satellites.

The satellite radio uplink facility may uplink GPS correction data to the satellite radio service network of one or more satellite radio geostationary satellites and/or satellite radio terrestrial repeaters or transmitters, as seen at block 220.

The GPS correction signal may be broadcast from one or more satellite radio geostationary satellites and/or satellite radio terrestrial transmitters, as seen at block 230.

The corrected mobile vehicle location may be determined based on GPS signals and the GPS correction signal. GPS correction signals may be received from a satellite radio geostationary satellite that broadcasts over at least a portion of a spectrum allocated for broadcasting of satellite radio transmissions. A satellite radio geostationary satellite and/or a satellite radio terrestrial transmitter may transmit radio signals with correction data to a satellite radio receiver in the mobile vehicle. The telematics unit may monitor broadcast signals from a satellite radio system for a GPS correction signal, as seen at block 240. The GPS correction signals may be transmitted on a prescribed channel of the satellite radio service.

The telematics unit may extract the GPS correction signal from the satellite radio broadcast signal, as seen at block 250. The broadcast channel may be monitored for particular command strings or protocol, and the GPS correction signal may be extracted for further processing when identified.

A GPS unit in the telematics unit may receive GPS signals from a plurality of GPS satellites, as seen at block 260. GPS signals from at least three GPS satellites may be used to determine the location of the mobile vehicle. The digital signal processor of the telematics unit may record the information, and compute the position of the mobile vehicle with or without the correction data. A computer application in the DSP may determine the corrected mobile vehicle location by correcting the GPS signals with the GPS correction signal and triangulating a vehicle position based on the corrected GPS signals.

Telematics service call centers may rely on the GPS location data received from a mobile vehicle that is requesting service and with more accurate vehicle position data, as provided by the current invention, telematics services such as navigation assistance, roadside assistance, information services assistance, fleet management, theft monitoring, and emergency assistance will become even more reliable and useful.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of determining a location of a mobile vehicle, comprising:
receiving a plurality of GPS signals in the mobile vehicle;
monitoring broadcast signals from a satellite radio system for at least one GPS correction signal;
extracting the GPS correction signal; and
determining a corrected mobile vehicle location based on the GPS signals and the GPS correction signal.

2. The method of claim 1 wherein the GPS correction signal is broadcast from one of a satellite radio geostationary satellite or a satellite radio terrestrial transmitter.

3. The method of claim 1 wherein determining the corrected mobile vehicle location comprises correcting the GPS signals based on the GPS correction signal and triangulating a vehicle position based on the corrected GPS signals.

4. The method of claim 1 wherein the GPS signals are received from at least three GPS satellites.

5. The method of claim 1 further comprising:
uplinking GPS correction data from a satellite radio uplink facility to a satellite radio geostationary satellite.

6. The method of claim 1 further comprising:
sending GPS correction data from a satellite radio uplink facility to a terrestrial radio transmitter.

7. A computer usable medium including a program for determining a location of a mobile vehicle comprising:
computer program code to receive a plurality of GPS signals in the mobile vehicle;
computer program code to monitor broadcast signals from a satellite radio system for at least one GPS correction signal;
computer program code to extract the GPS correction signal; and
computer program code to determine a corrected mobile vehicle location based on the GPS signals and the GPS correction signal.

8. The computer usable medium of claim 7 further comprising:
computer program code to uplink GPS correction data from a satellite radio uplink facility to a satellite radio geostationary satellite.

9. The computer usable medium of claim 7 further comprising:
computer program code to send GPS correction data from a satellite radio uplink facility to a terrestrial radio transmitter.

10. A system for determining a location of a mobile vehicle, comprising:
means for receiving a plurality of GPS signals in the mobile vehicle;
means for monitoring broadcast signals from a satellite radio system for at least one GPS correction signal;
means for extracting the GPS correction signal; and
means for determining a corrected mobile vehicle location based on the GPS signals and the GPS correction signal.

11. The system of claim 10 further comprising:
means for uplinking GPS correction data from a satellite radio uplink facility to a satellite radio geostationary satellite.

12. The system of claim 10 further comprising:
means for sending GPS correction data from a satellite radio uplink facility to a terrestrial radio transmitter.
